(19) United States
(12) Patent Application Publication
(10) Pub. No.: US 2013/0285456 A1
(43) Pub. Date: Oct. 31, 2013

(54) CONTROLLABLE ENERGY STORE AND METHOD FOR OPERATING A CONTROLLABLE ENERGY STORE

(71) Applicants: Peter Feuerstack, Ludwigsburg (DE); Erik Weissenborn, Stuttgart (DE); Martin Kessler, Schwaebisch Gmuend (DE)

(72) Inventors: Peter Feuerstack, Ludwigsburg (DE); Erik Weissenborn, Stuttgart (DE); Martin Kessler, Schwaebisch Gmuend (DE)

(73) Assignee: ROBERT BOSCH GMBH, Stuttgart (DE)

(21) Appl. No.: 13/997,851

(22) PCT Filed: Nov. 14, 2011
(86) PCT No.: PCT/EP11/70015

§ 371 Date: Jun. 25, 2013

(30) Foreign Application Priority Data
Dec. 29, 2010 (DE) 10 2010 064 311.4

(51) Int. Cl. H02J 1/10

(52) U.S. Cl. CPC H02J 1/10
USPC 307/71

(57) ABSTRACT

The invention relates to a controllable energy store (2) with n parallel energy supply branches (3-1, 3-2, 3-3), where n≧1, each of which comprises at least two serially connected energy storage modules (4). Each energy storage module comprises at least one electric energy storage cell (5) having an associated controllable coupling unit (6). The coupling units (6) bridge the associated power storage cells (5) in accordance with control signals or connect the associated energy storage cells to the respective energy storage branch (3-1; 3-2; 3-3). At least one energy storage module (4-11; 4-21; 4-31) is designed such that it has reduced switching losses, reduced in particular by at least 10% compared to the other energy storage modules (4) in the respective power supply branch (3-1; 3-2; 3-3).

### BACKGROUND OF THE INVENTION

The invention relates to a controllable energy store and to a method for operating a controllable energy store.

The trend is that in the future electronic systems which combine new energy store technologies with electrical drive technology will be used increasingly both in stationary applications, such as wind power plants, and in vehicles, such as hybrid or electric vehicles. In conventional applications, an electric machine which is in the form of a polyphase machine, for example, is controlled via a converter in the form of an inverter. A characteristic feature of such systems is a so-called DC voltage intermediate circuit, via which an energy store, generally a battery, is connected to the DC voltage side of the inverter. In order to be able to meet the requirements for a respective application placed on power and energy, a plurality of battery cells are connected in series. Since the current provided by such an energy store needs to flow through all of the battery cells and a battery cell can only conduct a limited current, battery cells are often additionally connected in parallel in order to increase the maximum current.

A series circuit comprising a plurality of battery cells entails the additional problem, in addition to a high total voltage, that the entire energy store fails when a single battery cell fails because no battery current can flow any more. Such a failure of the energy store can result in failure of the entire system. In the case of a vehicle, a failure of the drive battery can render the vehicle “unusable”. In other applications such as the rotor blade adjustment of wind power plants, for example, hazardous situations may even arise in the event of unfavorable boundary conditions, such as a strong wind, for example. Therefore, a high degree of reliability of the energy store is always desired, whereby “reliability” is intended to mean the capacity of a system to operate fault-free for a predetermined time.

In the earlier applications DE 10 2010 027857 and DE 10 2010 027861, batteries having a plurality of battery module strings have been described which can be connected directly to an electric machine. In this case the battery module strings have a plurality of series-connected battery modules, wherein each battery module has at least one battery cell and an associated controllable coupling unit, which makes it possible, depending on control signals, to interrupt the respective battery module string or to bypass the respectively associated at least one battery cell or to connect the respectively associated at least one battery cell into the respective battery module string. By suitably actuating the coupling units, for example with the aid of pulse width modulation, it is also possible for suitable phase signals for controlling the electric machine to be provided with the result that a separate pulse-controlled inverter is not required. The pulse-controlled inverter required for controlling the electric machine is therefore integrated in the battery, so to speak. For the purposes of the disclosure, these two earlier applications are incorporated in full in the present application.

### SUMMARY OF THE INVENTION

The present invention provides a controllable energy store with n parallel energy supply branches, where n≧1, which energy supply branches each have at least two series-connected energy storage modules, which each comprise at least one electrical energy storage cell with an associated controllable coupling unit. Depending on control signals, the coupling units bypass the respectively associated energy storage cells or they connect the respectively associated energy storage cells into the respective energy supply branch. In this case, at least one energy storage module is configured in such a way that, in comparison with the other energy storage modules in the respective energy supply branch, it has reduced switching losses, in particular switching losses reduced by at least 10%.

In addition, the invention provides a method for operating a controllable energy store according to the invention, wherein switching operations of the controllable energy store which can be implemented by the at least one energy storage module with reduced switching losses or by another energy storage module are increasingly, in particular always, implemented by the at least one energy storage module with reduced switching losses.

The switching operations in the coupling units which are required for connecting or routing the energy storage cells of an energy storage module produce switching losses which impair the energy efficiency of the controllable energy store. These switching losses are greater the greater the parasitic inductances in the energy storage modules affected. If the controllable energy store is intended to provide powers with orders of magnitude as are required for use in wind power plants or else in vehicles such as hybrid or electric vehicles, for example, the energy storage modules reach dimensions which have high parasitic inductances and therefore also high switching losses. The invention is based on the basic concept of providing individual energy storage modules which have reduced switching losses in comparison with the other energy storage modules in the respective energy supply branch and of using these energy storage modules to an increased extent for switching operations. In order to achieve a noticeable reduction in the switching losses of the entire controllable energy store, the switching losses of the energy storage modules with reduced switching losses should be at least 10%.

In order to enable a reduction in the switching losses in each of the energy supply branches in accordance with one embodiment of the invention, provision is made for at least one energy storage module with reduced switching losses, in particular switching losses reduced by at least 10%, to be arranged in each energy supply branch.

In accordance with one embodiment of the invention, the switching loss reduction in the at least one energy storage module is achieved in that the at least one energy storage module has a coupling unit which comprises a load-relief circuit for reducing the switching losses in the coupling unit. A load-relief circuit connected to the switching elements of a coupling unit makes it possible to reduce the switching losses and the resultant overvoltage by virtue of the fact that a current commutating onto the battery cells is first buffer-stored in a capacitor before the current is taken on by the parasitic inductance of the battery cells of the respective energy storage module. Then, the capacitor is discharged via an inductance in the load-relief circuit slowly to the voltage level of the respective energy storage module. In this case, no inherent losses result in the load-relief circuit.

In accordance with a further embodiment of the invention, the at least one energy storage cell of the at least one energy storage module with reduced switching losses has a lower parasitic inductance, in particular a parasitic inductance which is lower by at least 10%, in comparison with the energy storage cells of the other energy storage modules in the respective energy supply branch. The switching losses are greater the greater the parasitic inductance of the affected energy storage module. By virtue of actively reducing the parasitic inductance of the energy storage cells of an energy storage module, a reduction in the switching losses can therefore be achieved.

The parasitic inductance of energy storage cells is inter alia also dependent on the design of the energy storage cells. The fundamental rule applies here that a larger design also results in relatively large inductances since in particular the areas spanned between pole connections of the energy storage cells become bigger as the physical size increases. Therefore, a reduced parasitic capacitance in accordance with one embodiment of the invention is achieved by virtue of the fact that the at least one energy storage cell of the at least one energy storage module with reduced switching losses, has a smaller design in comparison with the energy storage cells of the other energy storage modules in the respective energy supply branch. In particular, an area spanned between pole connections of the at least one energy storage cell of the at least one energy storage module with reduced switching losses can be smaller, in particular smaller by at least 10%, than the area spanned between the pole connections of the energy storage cells of the other energy storage modules in the respective energy supply branch.

In accordance with a further embodiment of the invention, a reduced parasitic inductance of the associated energy storage cells is achieved for at least one energy storage module by virtue of the fact that these energy storage cells are configured as one or more capacitors. The configuration in the form of capacitors provides the additional possibility of matching the module voltage of a respective energy storage module to the present requirements during operation and thus reducing the number of required switching operations.

A reduced parasitic capacitance can also be achieved by virtue of the fact that the at least one energy storage module with reduced switching losses has a lower number of energy storage cells than the other energy storage modules in the respective energy supply branch. As a result, the total parasitic inductance of the energy storage cells of the energy storage module is reduced. In addition, the module voltage is reduced and a possible overvoltage is increased, on a percentage basis. All of these effects contribute to a reduction in the switching losses occurring.

The switching losses occurring at the switching elements of the coupling unit are dependent on the overvoltage which is permissible at these switches. The higher this voltage is, the more quickly the parasitic inductance present in a module can take on the operating current and the lower the switching losses will be. Therefore, in accordance with a further embodiment of the invention, provision is made for the coupling unit of the at least one energy storage module with reduced switching losses to have switching elements with an increased reverse voltage, in particular a reverse voltage which is increased by at least 10% in comparison with the switching elements of the other coupling units in the respective energy supply branch.

In order effectively to increase the energy efficiency of the controllable energy store according to the invention, switching operations of the controllable energy store which can be implemented by the at least one energy storage module with reduced switching losses or by another energy storage module are to an increased extent implemented by the at least one energy storage module with reduced switching losses. The term “to an increased extent” is in this case understood to mean in more than 50% of such selection situations the energy storage module with reduced switching losses is chosen. The switching operations are therefore concentrated on those energy storage modules which are implemented with circuitry which reduces the switching losses. A particularly marked reduction in the total switching losses is provided when all of the switching operations which can be implemented either by an energy storage module with reduced switching losses or another energy storage module are implemented by an energy storage module with reduced switching losses.

In accordance with one embodiment of the operating method according to the invention, a setpoint output voltage of an energy supply branch is adjusted by virtue of the fact that a coupling unit of at least one energy storage module with reduced switching losses is actuated in pulsed fashion in such a way that the arithmetic mean of the output voltage of an energy supply branch corresponds to the setpoint output voltage.

The earlier application DE 10 2010 041059 describes such a method for adjusting a setpoint output voltage of an energy supply branch of a controllable energy store in detail. For the purposes of the disclosure, this earlier application is incorporated in full in the present application.

In the case of the pulse-actuated switching operations which only take place in order to adjust a voltage value which is between two module voltages, it is in principle irrelevant in which energy storage module these switching operations are performed. If such switching operations are concentrated on the coupling units of energy storage modules with reduced switching losses, the total energy efficiency of the system increases. The remaining switching operations which result from energy storage cells remaining connected or being bypassed remain unchanged in this case.

### BRIEF DESCRIPTION OF THE DRAWINGS

Further features and advantages of embodiments of the invention result from the description below with reference to the attached drawings.

FIG. 1 shows a schematic illustration of a first embodiment of a controllable energy store according to the invention,

FIG. 2 shows a schematic detail illustration of an energy storage module with a load-relief circuit,

FIG. 3 shows a schematic illustration of a second embodiment of a controllable energy store according to the invention,

FIG. 4 shows a graphical illustration of the adjustable output voltages of an energy supply branch without pulsed actuation, and

FIG. 5 shows a graphical illustration of the adjustable output voltages of an energy supply branch with pulsed actuation.

### DETAILED DESCRIPTION

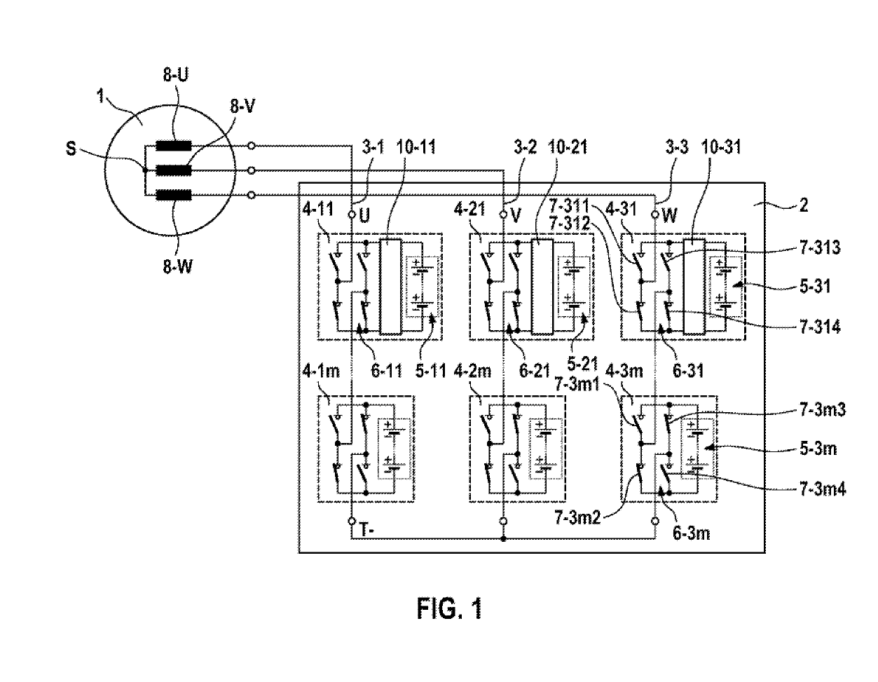

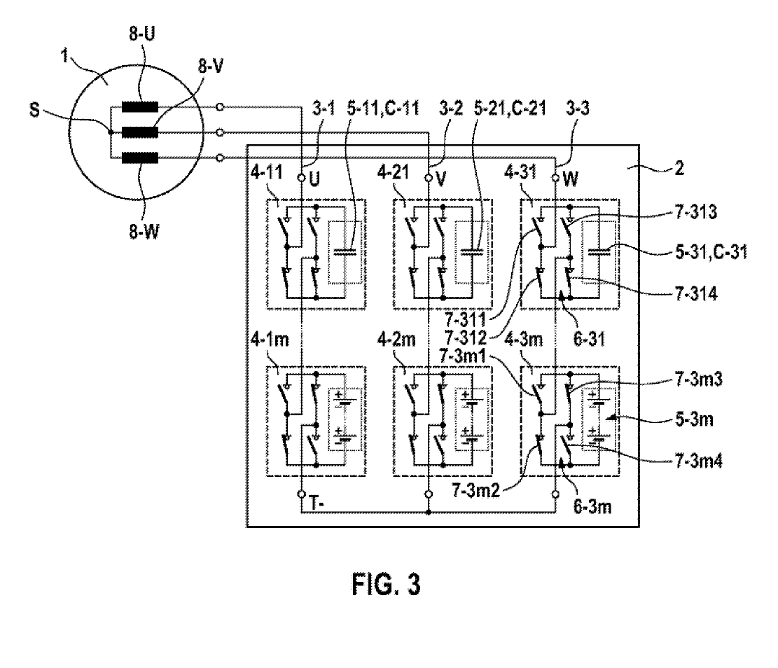

FIGS. 1 and 3 show schematic illustrations of embodiments of a controllable energy store according to the invention. A controllable energy store 2 is connected to a three-phase electric machine 1. The controllable energy store 2 comprises three energy supply branches 3-1, 3-2, and 3-3, which are connected firstly to a reference potential T-(reference rail), which conducts a low potential in the embodiments illustrated, and secondly in each case to individual phases U, V, W of the electric machine 1. Each of the energy supply branches 3-1, 3-2, and 3-3 have m series-connected energy storage modules 4-11 to 4-1m and 4-21 to 4-2m and 4-31 to 4-3m, respectively, where m is ≧2. In turn, the energy storage modules 4 each comprise a plurality of series-connected electrical energy storage cells, only some of which are provided with the reference symbols 5-11, 5-21 and 5-31 to 5-3m, for reasons of clarity. Furthermore, the energy storage modules 4 each comprise a coupling unit, which is associated with the energy storage cells 5 of the respective energy storage module 4. For reasons of clarity, only some coupling units are provided with the reference symbols 6-11, 6-21 and 6-31 to 6-3m. In the variant embodiments illustrated, the coupling units 6 are each formed by four controllable switching elements 7-311, 7-312, 7-313 and 7-314 to 7-3m1, 7-3m2, 7-3m3 and 7-3m4, which are interconnected in the form of a full bridge. In this case, the switching elements can be in the form of power semiconductor switches, for example, in the form of IGBTs (insulated gate bipolar transistors) or MOSFETs (metal oxide semiconductor field-effect transistors).

The coupling units 6 make it possible to interrupt the respective energy supply branch 3 by opening all switching elements 7 of a coupling unit 6. Alternatively, by closing of in each case two of the switching elements 7 of a coupling unit 6, the energy storage cells 5 can either be bypassed, for example by closing of the switches 7-312 and 7-314, or connected into the respective energy supply branch 3, for example closing of the switches 7-312 and 7-313.

The total output voltages of the energy supply branches 3-1 to 3-3 are determined by the respective switching state of the controllable switching elements 7 of the coupling unit 6 and can be adjusted stepwise. This stepwise adjustment results depending on the voltage of the individual energy storage modules 4. If the preferred embodiment of identically configured energy storage modules 4 is used as a basis, a maximum possible total output voltage results from the voltage of an individual energy storage module 4 times the number m of the energy storage modules 4 which are connected in series per energy supply branch 3.

The coupling units 6 therefore make it possible to connect the phases U, V, W of the electric machine 1 either to a high reference potential or to a low reference potential and to this extent can also perform the function of a known inverter. Thus, the power and mode of operation of the electric machine 1 can be controlled by the controllable energy store 2 given suitable actuation of the coupling units 6. The controllable energy store 2 therefore performs a dual function to this extent since it is used firstly for electrical energy supply and secondly also for controlling the electric machine 1.

The electric machine 1 has stator windings 8-U, 8-V and 8-W, which are star-connected to one another in a known manner.

In the exemplary embodiments illustrated, the electric machine 1 is in the form of a three-phase AC machine but can also have less than or more than three phases. The number of energy supply branches 3 in the controllable energy store 2 is naturally also dependent on the number of phases of the electric machine.

In the exemplary embodiments illustrated, each energy storage module 4 has in each case a plurality of series-connected energy storage cells 5. However, the energy storage modules 4 can also alternatively each have only one single energy storage cell or else parallel-connected energy storage cells.

In the exemplary embodiments illustrated, the coupling units 6 are each formed by four controllable switching elements 7 in the form of a full bridge, which also provides the possibility of a voltage reversal at the output of the energy storage module. However, the coupling units 6 can also be realized by more or less controllable switching elements as long as the required functions (bypassing of the energy supply cells and connection of the energy supply cells into the energy supply branch) can be realized. In particular, the coupling units can also be in the form of half-bridges. Such embodiments result, by way of example, from the earlier applications DE 10 2010 027857 and DE 10 2010 027861.

The switching operations in the coupling units 6 which are required for connecting or routing the energy storage cells 5 of an energy storage module 4 result in switching losses which impair the energy efficiency of the controllable energy store 2. These switching losses are greater the greater the parasitic inductances in the affected energy storage modules 4. If the controllable energy store 2 is intended to provide powers with orders of magnitude as are required, for example, for use in wind power plants or else in vehicles such as hybrid or electric vehicles, the energy storage modules 4 reach dimensions which have high parasitic inductances and therefore also high switching losses.

Therefore, provision is made according to the invention for at least one energy storage module 4, preferably at least one energy storage module 4 per energy supply branch 3, to be configured in such a way that it has reduced switching losses, in particular switching losses which are reduced by at least 10%, in comparison with the other energy storage modules 4 in the respective energy supply branch 3.

FIG. 1 shows a first embodiment of the invention, in which the reduction in the switching losses is achieved with the aid of load-relief circuits 10-11, 10-21 and 10-31. In each case one energy storage module, in the exemplary embodiment illustrated the energy storage modules 4-11, 4-21 and 4-31, is provided with a coupling unit 6-11, 6-21 and 6-31, respectively, in each energy supply branch 3-1, 3-2, and 3-3, which coupling units each comprise one of the load-relief circuits 10-11, 10-21 and 10-31, respectively. In this case, the load-relief circuits 10 are each connected between the switching elements 7 and the associated energy storage cells 5 of the respective energy storage module 4.

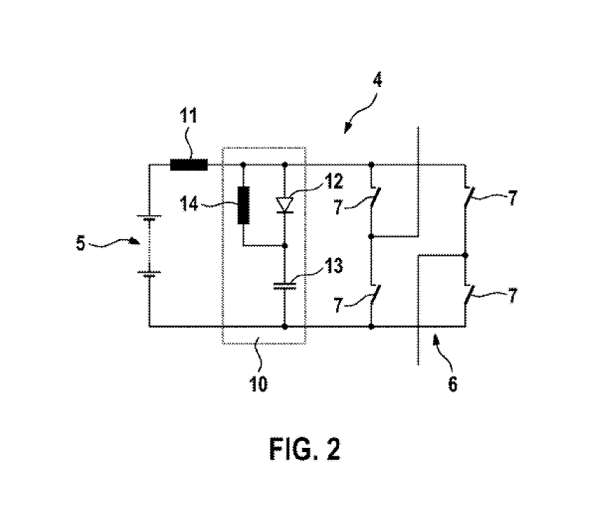

Load-relief circuits for switching elements are known in principle. FIG. 2 shows a schematic detail illustration of an energy storage module 4 with an exemplary embodiment of a load-relief circuit 10. Said figure also illustrates the parasitic inductance of the energy storage module 4, identified by the reference sign 11, which is in series with the energy storage cells 5. The load-relief circuit 10, which is connected in parallel between the energy storage cells 5 and the switching elements 7 of the coupling unit 6, comprises a series circuit comprising a diode 12 and a load-relief capacitor 13. A load-relief inductance 14 is connected in parallel with the diode. The arrangement shown makes it possible to reduce the switching losses and the resultant overvoltage by virtue of the fact that a current commutating onto the energy storage cells 5 is first buffer-stored via the diode 12 by the load-relief capacitor 13 before the current is taken on by the parasitic inductance 11 of the energy storage module 4. Then, the load-relief capacitor 13 is discharged via the load-relief inductance 14 slowly to the voltage level of the energy storage module 4. In this case, there are no inherent losses in the load-relief circuit 10. Instead of the diode 12, a controllable semiconductor switch can also be used.

In addition to the embodiment of the load-relief circuit 10 illustrated, it is also possible for any other desired load-relief circuit known from the prior art to be used.

The switching losses of an energy storage module 4 are greater the greater the parasitic inductance of the affected energy storage module 4. By virtue of actively reducing the parasitic inductance of the energy storage cells 5 of an energy storage module 4, preferably by at least 10%, a notable reduction in the switching losses can thus be achieved.

FIG. 3 shows a second embodiment of the invention in which the reduction in the parasitic inductance and therefore the switching losses is achieved in that in each case one energy storage module, in the exemplary embodiment illustrated the energy storage modules 4-11, 4-21 and 4-31, has energy storage cells 5-11, 5-21 and 5-31, respectively, which are configured as capacitors C-11, C-21 and C-31, respectively, in each energy supply branch 3-1, 3-2 and 3-3. Capacitors C have a reduced parasitic inductance inter alia owing to their smaller design in comparison with battery cells.

As an alternative to the configuration of energy storage cells 5 as capacitors C, a reduction in the parasitic inductance of an energy storage module 4 can also be achieved in that energy storage cells 4 with a design which is smaller in comparison with the energy storage cells 5 of the remaining energy storage modules 4 arranged in the respective energy supply branch 3. In this case, in particular energy storage cells 5 in which an area spanned between the pole connections of the energy storage cells 5 is reduced, preferably by at least 10%, can be used.

A reduction in the parasitic inductance of an energy storage module 4 can furthermore also be achieved in that the relevant energy storage module 4 has a lower number of energy storage cells 5 than the other energy storage modules 4 in the respective energy supply branch 3. As a result, the module voltage is additionally also reduced and a possible overvoltage is increased, on a percentage basis, which likewise contributes to a reduction in the switching losses.

The switching losses occurring at the switching elements 7 of the coupling units 6 are also dependent on the overvoltages which are permissible at these switching elements 7. The higher these voltages are, the more quickly the parasitic inductance present in an energy storage module 4 can take on the operating current and the lower the switching losses are. Accordingly, the switching losses in an energy storage module 4 and therefore in the controllable energy store 2 can also be reduced by virtue of the fact that the coupling unit of the relevant energy storage module 4 has switching elements 7, which have an increased reverse voltage in comparison with the switching elements 7 of the other coupling units 6 in the respective energy supply branch 3. The increase in this case is advantageously at least 10%.

In the exemplary embodiments illustrated, in each case one energy storage module 4 with reduced switching losses is provided in each of the energy supply branches 3. However, it is noted that firstly a plurality of energy storage modules 4 with reduced switching losses can also be arranged in one energy supply branch. Secondly, energy storage modules with reduced switching losses do not necessarily need to be provided in each energy supply branch 3.

In order to increase the energy efficiency of the controllable energy store 2, switching operations of the controllable energy store 2 which can be implemented by an energy storage module 4-11, 4-21 or 4-31 with reduced switching losses or by another energy storage module 4 are implemented to an increased extent, in particular always, by an energy storage module 4-11, 4-21 or 4-31 with reduced losses.

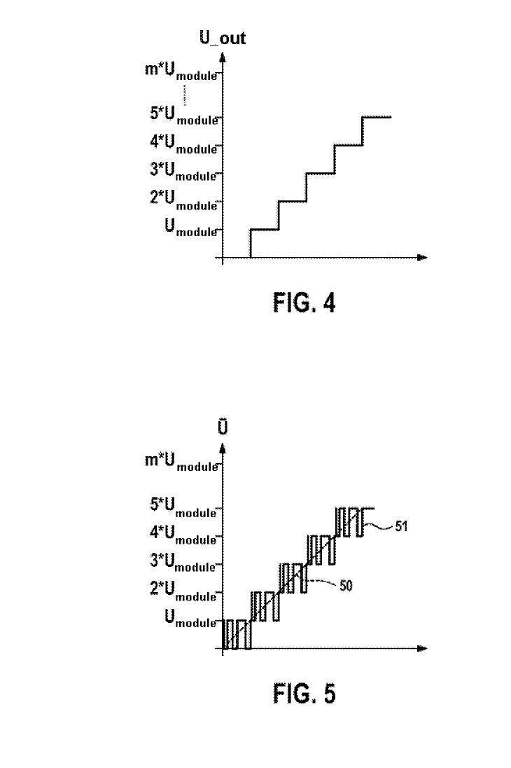

The total output voltages of the energy supply branches 3-1 to 3-3 are determined by the respective switching state of the controllable switching elements 7 of the coupling units 6 and can be adjusted stepwise. The stepwise adjustment results in this case depending on the voltage of the individual energy storage modules 4. If the preferred embodiment of identically configured energy storage modules 4 is used as a basis, a maximum possible total output voltage U_out results from the voltage of an individual energy storage module 4 times the number m of the energy storage modules 4 which are connected in series per energy supply branch. Such an output voltage that is adjustable stepwise of an energy supply branch 3 is illustrated schematically in FIG. 4.

The earlier application DE 10 2010 041059 discloses a method by means of which a setpoint output voltage U_set can also be adjusted, which is between two voltage levels. For this purpose, one of the coupling units 6 in the affected energy supply branch 3 is actuated in pulsed fashion with a pre-determinable duty factor in such a way that the arithmetic mean of the total output voltage U_out of an energy supply branch 3 corresponds to the setpoint output voltage U_set. In this case, the energy storage cells 5 associated in each case with this coupling unit 6, are connected into the respective energy supply branch 3 during a pulse period and are bypassed during an interpulse period. FIG. 5 shows schematically the output voltages which are adjustable with the aid of this method at an energy supply branch 3. The output voltage which is adjustable stepwise is in this case identified by the reference symbol 50. A basic illustration of the pulsed actuating signals is identified by the reference symbol 51. Similarly to the illustration in FIG. 4, the preferred embodiment of identically configured energy storage modules 4 is also assumed in the illustration in FIG. 5.

When applying the method, it is in principle irrelevant which coupling unit 6 is actuated in pulsed fashion. The energy efficiency of the controllable energy store 1 can consequently be increased by virtue of the fact that a coupling unit 6 of an energy storage module 4 with reduced switching losses is used for this purpose.

1. A controllable energy store (2) with n parallel energy supply branches (3-1, 3-2, 3-3), where n≧1, which energy supply branches each have at least two series-connected energy storage modules (4), which each comprise at least one electrical energy storage cell (5) with an associated controllable coupling unit (6), wherein the coupling units (6), depending on control signals, bypass the respectively associated energy storage cells (5) or connect the respectively associated energy storage cells (5) into the respective energy supply branch (3-1; 3-2; 3-3), and wherein at least one energy storage module (4-11; 4-21; 4-31) is configured in such a way that, in comparison with the other energy storage modules (4) in the respective energy supply branch (3-1; 3-2; 3-3), it has reduced switching losses.

2. The controllable energy store as claimed in claim 1, wherein at least one energy storage module (4-11; 4-21; 4-31) with reduced switching losses is arranged in each energy supply branch (3-1, 3-2, 3-3).

3. The controllable energy store as claimed in claim 1, wherein the at least one energy storage module (4-11; 4-21; 4-31) with reduced switching losses has a coupling unit (6-11; 6-21; 6-31), which comprises a load-relief circuit (10-11; 10-21; 10-31) for reducing switching losses in the coupling unit (6-11; 6-21; 6-31).

4. The controllable energy store as claimed in claim 1, wherein the at least one energy storage cell (5-11; 5-21; 5-31) of the at least one energy storage module (4-11; 4-21; 4-31) with reduced switching losses has a lower parasitic inductance in comparison with the energy storage cells (5) of the other energy storage modules (4) in the respective energy supply branch (3 1; 3-2; 3-3).

5. The controllable energy store as claimed in claim 4, wherein the at least one energy storage cell (5-11; 5-21; 5-31) of the at least one energy storage module (4-11; 4-21; 4-31) with reduced switching losses, has a smaller design in comparison with the energy storage cells (5) of the other energy storage modules (4) in the respective energy supply branch (3-1; 3-2; 3-3).

6. The controllable energy store as claimed in claim 5, wherein an area spanned between pole connections of the at least one energy storage cell (5-11; 5-21; 5-31) of the at least one energy storage module (4-11; 4-21; 4-31) with reduced switching losses is smaller than the area spanned between the pole connections of the energy storage cells (5) of the other energy storage modules (4) in the respective energy supply branch (3-1; 3-2; 3-3).

7. The controllable energy store as claimed in claim 1, wherein the at least one energy storage cell (5-11; 5-21; 5-31) of the at least one energy storage module (4-11; 4-21; 4-31) with reduced switching losses is configured as a capacitor (C-11; C-21; C-31).

8. The controllable energy store as claimed in claim 1, wherein the at least one energy storage module (4-11; 4-21; 4-31) with reduced switching losses has a lower number of energy storage cells (5-11; 5-21; 5-31) than the other energy storage modules (4) in the respective energy supply branch (3-1; 3-2; 3-3).

9. The controllable energy store as claimed in claim 1, wherein the coupling unit (6-11; 6-21; 6-31) of the at least one energy storage module (4-11; 4-21; 4-31) with reduced switching losses has switching elements (7) with an increased reverse voltage.

10. A method for operating a controllable energy store (2) as claimed in claim 1, wherein switching operations of the controllable energy store (2) which can be implemented by the at least one energy storage module (4-11; 4-21; 4-31) with reduced switching losses or by another energy storage module (4) are to an increased extent implemented by the at least one energy storage module with reduced switching losses.

11. The method as claimed in claim 10, wherein a setpoint output voltage (U_set) of an energy supply branch (3-1; 3-2; 3-3) is adjusted by virtue of the fact that a coupling unit (6-11; 6-21; 6-31) of at least one energy storage module (4-11; 4-21; 4-31) with reduced switching losses is actuated in pulsed fashion in such a way that the arithmetic mean of the output voltage (U_out) of an energy supply branch (3-1; 3-2; 3-3) corresponds to the setpoint output voltage (U_set).

12. The controllable energy store as claimed in claim 1, wherein the switching losses are reduced by at least 10%.

13. The controllable energy store as claimed in claim 2, wherein the-switching losses are reduced by at least 10%.

14. The controllable energy store as claimed in claim 4, wherein the lower parasitic inductance is lower by at least 10% in comparison with the energy storage cells (5) of the other energy storage modules (4) in the respective energy supply branch (3 1; 3-2; 3-3).

15. The controllable energy store as claimed in claim 5, wherein the switching losses are smaller by at least 10%.

16. The controllable energy store as claimed in claim 9, wherein the reverse voltage is increased by at least 10% in comparison with the switching elements (7) of the other coupling units (6) in the respective energy supply branch.

17. The method as claimed in claim 10, wherein switching operations of the controllable energy store (2) which can be implemented by the at least one energy storage module (4-11; 4-21; 4-31) with reduced switching losses or by another energy storage module (4) are always implemented by the at least one energy storage module with reduced switching losses.
